(19) United States
(12) Patent Application Publication
(10) Pub. No.: US 2012/0066536 A1
(43) Pub. Date: Mar. 15, 2012

(54) Systems And Methods For Delivering Power

(76) Inventors: Ronnie Gozun, Taiwan (CN); Michael C. McCullough, San Jose, CA (US)

(21) Appl. No.: 13/320,657

(22) PCT Filed: Jun. 25, 2009
(86) PCT No.: PCT/US2009/048661

§ 371 Date: Nov. 15, 2011

(51) Int. Cl. G06F 1/28

(52) U.S. Cl. 713/340

(57) ABSTRACT

An exemplary embodiment of the present invention provides a system and method of delivering power. An exemplary method includes providing electrical current to a load and generating a reference value corresponding to a power provided to the load. The exemplary method also includes generating a time reference if the reference value is greater than or equal to a threshold value corresponding to a power boundary. If the time reference reaches a time boundary a power regulation event is initiated.

### BACKGROUND

Electronic devices are generally designed to not exceed certain power levels. For example, switching power supplies may be designed to limit user-accessible electrical outputs, or “rails,” to less than 240 Volts-Amperes (VA) over any one sixty-second period. To perform this function, many electronic devices include an over-current protection mechanism that causes the electrical output to be immediately deactivated if the power exceeds a specified power level.

However, many electronic devices can cause instantaneous peak power to spike for short periods. For example, a graphics card for a gaming computer may experience a short burst of graphics processing that causes the graphics card to draw large amounts of power for a short time. Typically, exceeding a specified power level, even for a short time, will trigger the over-current protection, shutting down the unit. Therefore, to avoid drawing too much power from any one rail, electronic devices may include several high-power rails so that power consumption can be distributed between the rails.

### BRIEF DESCRIPTION OF THE DRAWINGS

Certain exemplary embodiments are described in the following detailed description and in reference to the drawings, in which:

FIG. 1 is a partial cutaway perspective view of a computing device with a power supply unit, in accordance with exemplary embodiments of the present invention;

FIG. 2 is a block diagram of the power supply unit shown in FIG. 1, in accordance with an exemplary embodiment of the present invention;

FIG. 3 is a more detailed block diagram of the power supply unit shown in FIG. 1, in accordance with an exemplary embodiment of the present invention;

FIG. 4 is timing diagram showing the operation of a power supply unit, in accordance with an exemplary embodiment of the present invention; and

FIG. 5 is a process flow diagram showing a method of delivering power, in accordance with an exemplary embodiment of the present invention.

### DETAILED DESCRIPTION OF SPECIFIC EMBODIMENTS

Exemplary embodiments of the present invention relate to systems and methods for regulating output power of a power rail in a computer system. Moreover, an exemplary embodiment provides a power supply unit (PSU) with a power regulator that prevents an electrical output of the PSU from exceeding a specified power boundary for more than a specified length of time, for example, 240 VA for 60 seconds. A timer begins tracking time if the power level of the output exceeds the specified power boundary. If the power level of the output falls below the specified power boundary before the timer reaches the specified length of time, the timer resets, and the output power is not interrupted. However, if the power level of the output remains above the specified power boundary long enough for the timer to reach the specified length of time, the power regulator turns off the electrical output. In this way, the power regulator may enable an electrical output of the PSU to exceed a specified power boundary for a short time without causing interruption of the electrical output. Therefore, the PSU may provide instantaneous peak power per rail greater than the power boundary without triggering a shutdown. By increasing the instantaneous peak power available from each rail, the PSU may include fewer high voltage rails, lowering the cost of the unit.

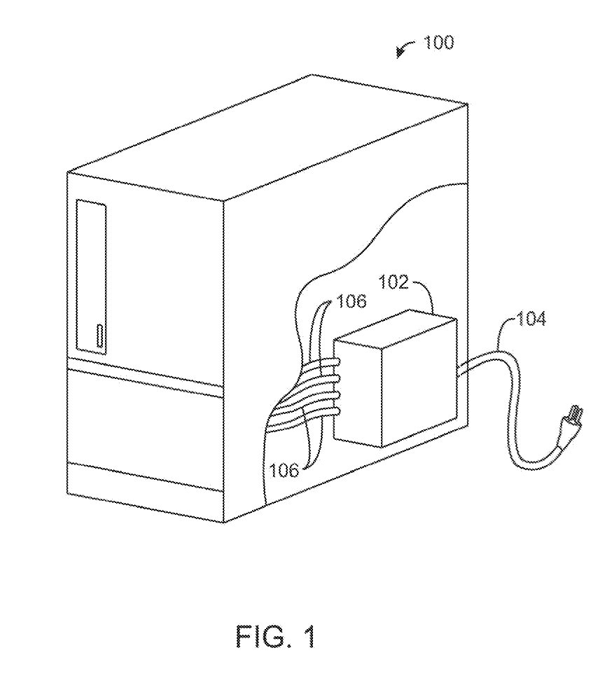

FIG. 1 is a partial cutaway perspective view of a computer 100 with a PSU 102, in accordance with exemplary embodiments of the present invention. In an exemplary embodiment of the present invention, the computer 100 may be a desktop computer, which may be used for PC gaming, for example. The PSU 102 may be electrically coupled to an alternating-current (AC) power source through the input 104 and may generate a direct-current (DC) voltage that is applied to one or more rails 106 that provide power to various components of the computer 100. For example, the PSU 102 may include one rail 106 that provides an output voltage of approximately 3.3 Volts, one rail that provides an output voltage of approximately 5.0 Volts, and one or more rails that provide an output voltage of approximately 12.0 Volts. In exemplary embodiments of the present invention, the PSU 102 may include a single high-power rail on one or more of these voltage rails, thereby reducing the cost of the PSU 102. The power rails 106 may be routed to various components of the computer 100, for example, processors, displays, memory devices, graphics cards, I/O cards, and the like.

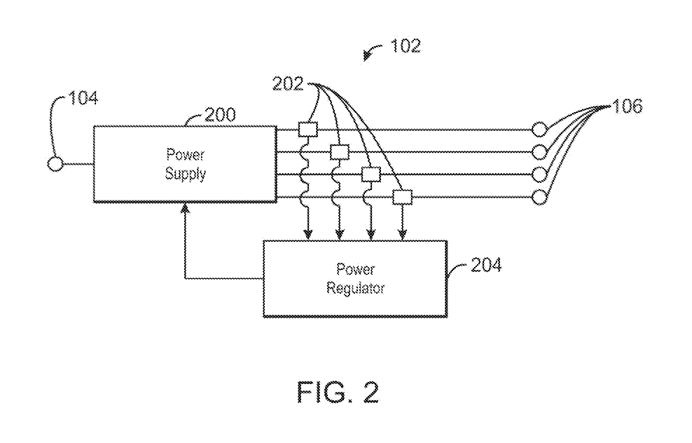

FIG. 2 is a block diagram of the PSU shown in FIG. 1, in accordance with an exemplary embodiment of the present invention. The PSU 102 may include a power supply 200, sensors 202, and a power regulator 204. The power supply 200 receives input power from the AC input 104 and delivers DC power to the one or more rails 106, as discussed with reference to FIG. 1. In exemplary embodiments, the power supply 200 may be a linear or switched-mode power supply and may include one or more transformers, switches, rectifiers, solid state switches, and the like. The sensors 202 may detect an electrical characteristic of the output rail 106, for example, current. The sensors 202 may include current sensing resistors, hall-effect current sensors, and the like.

The signal generated by the sensors 202 may be sent to the power regulator 204, which may interrupt the power delivered along one or more of the power rails 106, based, at least in part, on the measured values provided by the sensors 202. Accordingly, the power regulator 204 may include various circuitry and control logic configured to execute the various operational aspects of the power regulator, for example comparators, operational amplifiers, timers, counters, processors, discrete electronics, logic gates, latches, computer memory, and the like.

In exemplary embodiments of the present invention, the power regulator 204 may convert the output signal of the sensor 202 to a reference value that corresponds with the power being delivered through the rail. Individual reference values may be generated for each of the rails 106. The reference value may be converted into a digital signal and sent to a processor. The power regulator 204 may then compare the reference value to a threshold value that corresponds with a specified power boundary. If the reference value is greater than or equal to the threshold value, the power regulator 204 may begin generatin a time reference, defined as the length of time since the reference value crossed the threshold value. Subsequently, if the time reference meets or exceeds a specified time threshold, the power regulator 204 may generate a power regulation event that interrupts the delivery of power on or more of the rails 106.

In exemplary embodiments of the present invention, the power threshold and the time threshold may be determined by the power handling capacity of the attached devices. In other exemplary embodiments, the power-related threshold and the time threshold may correspond with power boundaries and time boundaries specified in an industry standard. For example, in some exemplary embodiments, the power-related threshold may correspond with a power of approximately 240 VA and the time threshold may be approximately 60 seconds or less.

Furthermore, exemplary embodiments of the present invention may include various techniques for interrupting the delivery of power on the output rails 106. In some exemplary embodiments, a power regulation event may include turning off the power to all of the output rails 106. In other exemplary embodiments, the power regulation event may include turning off only the power to the rail 106 that triggered the power regulation event.

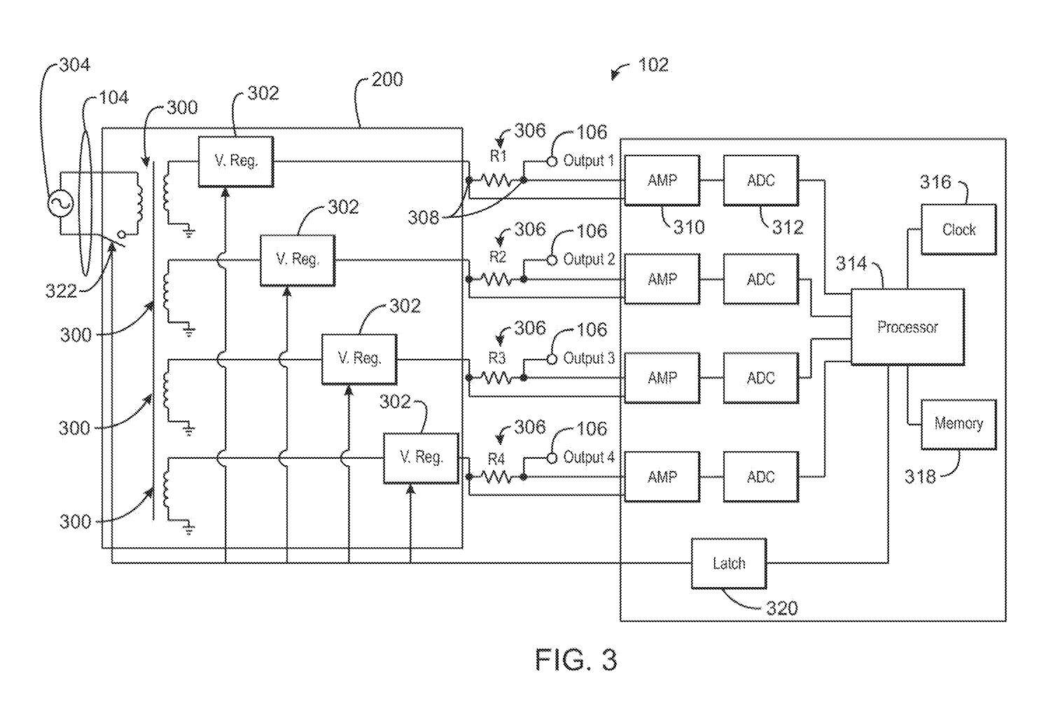

FIG. 3 is a more detailed block diagram of a PSU, in accordance with an exemplary embodiment of the present invention. In exemplary embodiments, the power supply 200 may include one or more transformers 300 and one or more voltage regulators 302. The power supply 200 may be coupled to any suitable AC power supply 304, for example, 120 volt, single-phase AC, or three-phase AC. The transformers 300 reduce the voltage level provided by the AC power supply 304 down to a voltage level suitable for the voltage regulators 302. The voltage regulators 302 convert the AC power from the transformers 300 to the desired DC voltage to be applied to each of the power rails 106. The voltage regulators 302 may include any suitable kind of voltage regulator, for example, linear voltage regulators, switched-mode regulators, silicon controlled rectifier (SCR) regulators, and the like.

Additionally, the voltage regulators may include various power conditioning circuitry, for example, capacitors and inductors to smooth the direct current (DC) output.

In exemplary embodiments of the present invention, the reference value corresponding to the output power of the rail 106 may be generated by a current sensing resistor 306. The current sensing resistor 306 may be disposed in series with the power rail 106 at the output of the voltage regulators 302. Leads 308 may be coupled to each side of the resistor 106 to provide the voltage generated across the resistor 306 to the power regulator 204. The resistor 306 may include any suitable kind of resistor, for example, wire-wound, metal-film, and the like. In some exemplary embodiments, the resistor 306 may be a portion of the conductor leading out of the voltage regulator 302, rather than a discrete resistor. For example, the resistor 306 may be provided by coupling the leads 308 at two points along a portion of a conductor on a printed circuit board (PCB) included in the voltage regulator 302. The resistance of resistor 306 may be in the range of less than one milli-Ohm to about 100 milli-Ohms. The voltage generated by the resistor 306 is proportional to the resistance and the current and, thus, the power delivered via the rail 106. Therefore, the reference value, in this case, may be a reference voltage that corresponds with the power delivered by the rail 106. Accordingly, the threshold value may be a threshold voltage that corresponds with the specified power boundary.

In exemplary embodiments of the present invention, the power regulator 204 may include an amplifier 310, an analog-to-digital converter (ADC) 312, a processor 314, a clock 316, a memory 318, and a latch 320. The power regulator 204 receives the reference voltage from each of the resistors 306 and compares the reference voltage to the threshold voltage. It will be appreciated that the voltage generated by the resistor 306 may be as small as a few millivolts. Accordingly, the voltage generated by the resistor 306 may be amplified by the amplifier 310 to increase the voltage to a level suitable for the ADC 312. The output of the amplifier 310 may be coupled to the input of the ADC 312, which converts the amplified voltage into a digital signal suitable for the processor 314. Accordingly, the reference voltage received by the processor 314 may equal the voltage generated across the resistor 306 multiplied by the gain of the amplifier 310. Therefore, the gain of the amplifier 310 may also be included in the calculation of the threshold voltage. In exemplary embodiments of the present invention, the threshold voltage may be calculated according to the following formula:

$${V}_{th} = ( \frac{{P}_{th}}{{V}_{nom}} \cdot R ) \cdot {A}_{v}$$

In this equation, Vₜₕ, is the threshold voltage; Pₜₕ is the specified power boundary; Vₙₒₘ is the nominal output voltage of the rail 106; R is the resistance value of the resistor 306; and Aᵥ is the voltage gain of the amplifier 310. In exemplary embodiments of the present invention, the threshold voltage may be programmed into the voltage regulator 204, for example, the processor 314 or the memory 318. In other exemplary embodiments, one or more of the variables described in the formula above may be stored in the memory 318, and the processor 314 may calculate the threshold voltage based on the stored values. In another exemplary embodiment, the threshold voltage may be generated by an outside voltage reference (not shown), and used, for example, by the ADC to generate a digital signal representing the difference between the threshold voltage and the reference voltage.

Upon receiving the reference voltage, the processor 314 compares the reference voltage with the threshold voltage to determine whether the output power of the power supply 200 has exceeded the specified power boundary on any one of the power rails 106. If a power rail 106 does exceed the power boundary, then the processor 314 beings tracking a time reference. In an exemplary embodiment, tracking a time reference may include counting clock pulses of a clock 316. If the time reference exceeds the specified time threshold, then the processor 314 may trigger the power regulation event by sending a shutdown signal to the latch 320. The power regulation event may include turning off the power rail 106 that caused the power regulation event. Additionally, the power regulation event may include turning off several or all of the power rails 106.

In exemplary embodiments of the present invention, the power regulation event may be performed through the latch 320, which may include, for example, a latching relay, a solid-state relay, a flip-flop, and the like. In exemplary embodiments, the latch 320 may send a deactivation signal to one or more of the voltage regulators 302, causing the output of the respective voltage regulator 302 to drop to zero volts. Accordingly, the latch 320 may send a deactivation signal to a switch disposed in the voltage regulator 302 and configured to decouple the voltage regulator 302 from the respective transformer 300 or the respective power rail 106. The latch 320 may send a deactivation signal to a switch 322 disposed at the input of the power supply 200 and configured to decouple the input of the power supply 200 from the AC source 304. Furthermore, in some exemplary embodiments the latch 320 may include several latches, each controlled separately by the processor 314 and each coupled to a one of the voltage regulators 302 or the switch 322. In this way, the processor 314 may deactivate the voltage regulators 302 individually or all together.

The memory 318 may be a tangible, computer readable media that can store programs and data that may be used by the processor 314. The memory 318 can include a read-only memory (ROM), a programmable ROM (PROM), and electrically-erasable programmable ROM (EEPROM), among others. The memory 318 can also include random access memory (RAM) for storing program instructions and data during operation of the processor 314. Further, the memory 318 can include units for longer term storage of programs and data, such as a hard disk drive or an optical disk drive, CD-ROM drives, DVD-ROM drives, CD/RW drives, DVD/RW drives, Blu-Ray drives, flash drives and the like. The memory 318 can store machine-readable instructions such as computer code that, when executed by the processor 314, cause the processor 314 to perform a method according to an exemplary embodiment of the present invention. Furthermore, the memory 318 may store parameters used by the processor to calculate the voltage threshold.

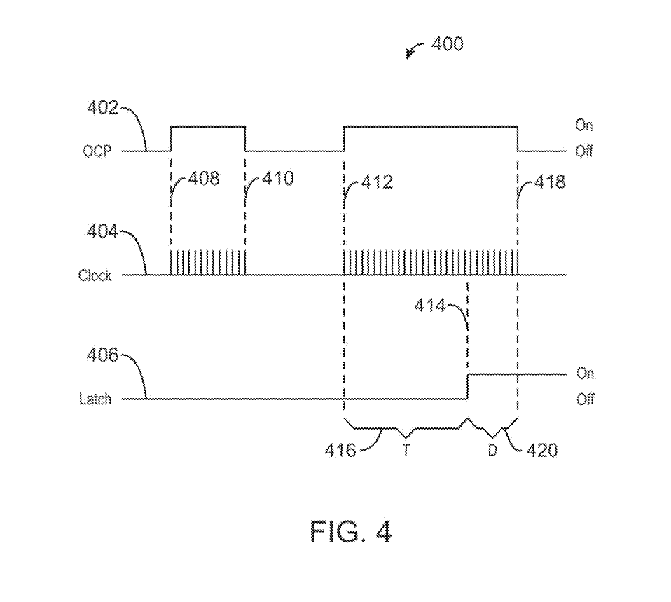

FIG. 4 is timing diagram showing the operation of a PSU in accordance with an exemplary embodiment of the present invention. In exemplary embodiments, the operation of the power regulator 204 may be based on three signals, an over-current protection (OCP) signal 402, a clock signal 404, and a latch signal 406. The OCP signal 402 corresponds to a comparison of the reference voltage and the threshold voltage. The OCP signal 402 may be high (logical one) when the reference voltage is greater than or equal to the threshold voltage, and may be low (logical zero) when the reference voltage is less than the threshold voltage. The clock signal 404 represents the counting of clock pulses that occurs when the reference voltage is greater than or equal to the threshold voltage. Accordingly, the clock signal 404 may turned on when the OCP signal 402 is high and may be turned off when the OCP signal 402 is low. The latch signal 406 represents the triggering of the power regulation event. If the latch signal 406 is off, the power output of the power supply 200 is not interrupted. If the latch signal 406 is on, the power regulation event is triggered. The timing diagram 400 shows the interaction of these signals, in accordance with exemplary embodiment of the present invention. It should be noted that the timing diagram 400 is not drawn to scale.

At transition 408, the OCP signal 402 goes high in response to the reference voltage exceeding the threshold voltage, as discussed in reference to FIG. 3. This may be due to increased power consumption of one or more of the devices coupled to the rail 106, for example, an increased processor activity on a graphics card. In response to the OCP signal 402 going high, the clock signal 404 may begin to pulse. Each pulse of the clock signal 404 increments the time reference.

Next, at transition 410, the OCP signal goes low in response to the reference voltage falling back below the threshold voltage, as discussed in reference to FIG. 3. Accordingly, at transition 410, the clock signal 404 stops pulsing and the time reference may be reset to zero. It will be noticed that the latch signal 406 remains off during the period between transition 408 and 410. This may be attributed to the fact that the OCP signal 402 did not remain high long enough for the time reference to reach the specified time threshold.

Accordingly, during the period between transition 408 and transition 410 the output power of the respective rail 106 exceeds the power boundary without causing a power regulation event. In this way, the PSU 102 may be able to provide instantaneous peak power greater than the power boundary without triggering a power regulation event and without exceeding the specified power and time boundaries.

At transition 412 the OCP signal 402 again goes high in response to the sensed power exceeding the threshold power. As discussed above, the clock signal 404 begins to pulse and the time reference increments. At transition 414, after the OCP signal 402 has been high for a period of time equal to the time threshold 416, the latch signal 406 turns on. As a result, the power regulator 204 triggers the power regulation event by sending a signal to the power supply 200 that deactivates one or more of the output power rails 106. The latch signal 420 may remain high until a user manually re-activates the PSU 102.

Next, at transition 420, the OCP signal 402 goes low in response to the output power of the rail falling back below the power threshold, and the clock signal 404 stops pulsing. It will be noticed that the OCP signal 402 may remain high for a length of time greater than the time threshold. This may be attributed to a response time or delay 420 that may exist between the time the latch signal 406 goes high and the output power on the rail falls below the power boundary. Accordingly, the time threshold 416 may be determined such that the sum of the time threshold 416 and the delay time 420 will be equal to or less than a desired time boundary, which may, for example, be specified in an applicable electrical standard. It should be noted that the timing diagram 400 is not drawn to scale and is not intended to provide a representation of an actual delay time 420.

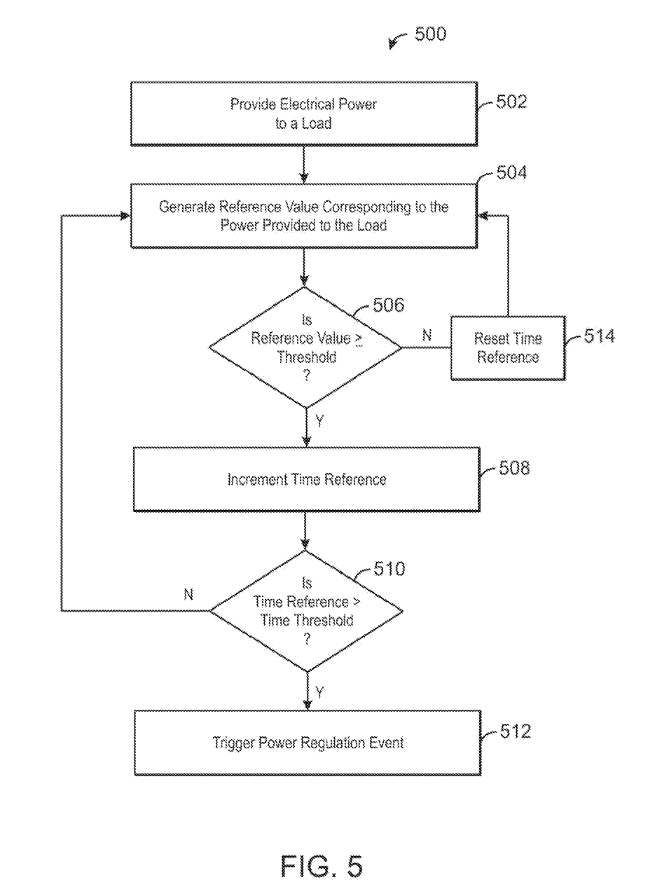

FIG. 5 is a process flow diagram showing a method of delivering power, in accordance with an exemplary embodiment of the present invention. The method is generally referred to by the reference number 500. At block 502, electrical power is delivered to a load, as discussed above in relation to FIGS. 2 and 3. Next, at block 504, a reference value is generated that corresponds to the power being delivered to the load.

In some exemplary embodiments of the present invention, the reference value may be generated by sensing a current provided to the load. For example, a sensor disposed about a conductor carrying current to the load may generate a reference voltage.

At block 506, a determination is made regarding whether the reference value is greater than a specified threshold corresponding to a power boundary. If the reference value is greater than the specified threshold, then method 500 advances to block 508, wherein a time reference is incremented.

After incrementing the time reference, a determination is made at block 510 regarding whether the time reference is above the specified time threshold. If the time reference is not greater than the time threshold, then the method returns to block 504 and the delivery of power to the load continues uninterrupted. If however, the time reference is greater than the time threshold, then the method 500 advances to block 512 and a power regulation event is triggered, for example, the power may be turned off.

Returning to block 506, if the reference value is not greater than the threshold, then the method advances to block 514, wherein the time reference is reset. After resetting the time reference at block 514, the method returns to step 504, and the delivery of power to the load continues uninterrupted.

What is claimed is:

1. A method of delivering power, comprising:
providing electrical current to a load;
generating a reference value corresponding to a power provided to the load;
generating a time reference if the reference value is greater than or equal to a threshold value corresponding to a power boundary; and
initiating a power regulation event if the time reference exceeds a time boundary.

2. The method of claim 1, wherein generating a reference value comprises sensing the current provided to the load.

3. The method of claim 2, wherein sensing the current comprises sensing a voltage generated across a trace on a circuit board that is disposed in series with the load.

4. The method of claim 1, wherein initiating the power regulation event comprises turning off the current.

5. The method of claim 1, further comprising stopping the time reference if the reference value falls below the threshold value.

6. A power supply unit, comprising:
a power supply configured to provide current to a load;
a sensor configured to sense the current provided to the load; and
a power regulator configured to receive an output of the sensor and to generate a reference value based on the output of the sensor corresponding to a power provided to the load, the power regulator being configured to initiate a power regulation event if the reference value is greater than or equal to a threshold value for a specified length of time.

7. The power supply unit of claim 6, wherein the sensor comprises a current sensing resistor disposed in series with the load;

8. The power supply unit of claim 7, wherein the current sensing resistor comprises a portion of a conductor that provides the current to the load.

9. The power supply unit of claim 6, wherein the power regulator comprises a processor configured to measure a length of time that the reference value is greater than or equal to the threshold value.

10. The power supply unit of claim 6, wherein the threshold value corresponds with a power of approximately 240 Volts-Amps and the specified length of time is approximately sixty seconds.

11. A computer system, comprising:
a power supply configured to power a computing device through a rail;
a sensor disposed about the rail and configured to sense a current provided to the computing device; and
a power regulator configured to receive an output of the sensor and generate a reference value based on the output of the sensor corresponding to a power provided to the computing device, wherein the power regulator is configured to reduce the power provided to the computing device if the reference value is greater than or equal to a threshold power for a specified length of time.

12. The computer system of claim 11, wherein the sensor comprises a current sensing resistor disposed in series with the load;

13. The computer system of claim 12, wherein the current sensing resistor comprises a portion of a conductor disposed on a circuit board that provides power to the rail.

14. The computer system of claim 11, wherein the power regulator comprises a control circuitry configured to measure a length of time that the reference value is greater than or equal to the threshold value

15. The computer system of claim 11, wherein the threshold power is approximately 240 Volts-Amps and the specified length of time is approximately sixty seconds.
